(19) United States
(12) Patent Application Publication
(10) Pub. No.: US 2019/0099661 A1
(43) Pub. Date: Apr. 4, 2019

(54) CASINO BLACKJACK BONUS POKER BET TRIGGERED BY DEALER HAND

(71) Applicant: AGS LLC, Las Vegas, NV (US)

(72) Inventors: Ronald LaDuca, Cherry Hill, NJ (US); Todd Fishon, Henderson, NV (US)

(21) Appl. No.: 16/208,223

(22) Filed: Dec. 3, 2018

Related U.S. Application Data
(63) Continuation of application No. 14/548,227, filed on Nov. 19, 2014.
(60) Provisional application No. 61/998,825, filed on Jul. 9, 2014.

(51) Int. Cl. A63F 3/00; G07F 17/32; A63F 1/00

(52) U.S. Cl. CPC A63F 3/00157; G07F 17/3258; A63F 2003/00167; A63F 1/00; G07F 17/3293; G07F 17/3267

(57) ABSTRACT

A method of combining an optional bonus poker hand side bet with a casino Blackjack card game that requires the dealer's hand to have a qualifying event to trigger a payout of the optional bonus side bet designated poker hand against a payout table. Normal casino Blackjack play regulations are followed. If no dealer trigger hand occurs the optional bonus side bet loses. A progressive poker bonus bet jackpot may be accumulated by portions of the bets at all casino Blackjack tables.

### RELATED APPLICATION DATA

This application is a continuation of U.S. patent application Ser. No. 14/548,227, filed Nov. 19, 2014, which claims the priority of U.S. Provisional Patent Application Ser. No. 61/998,825, filed Jul. 9, 2014. The present application claims priority to each of said applications and incorporates by reference each of said applications as if set forth fully herein.

### FIELD OF THE INVENTION

The present invention relates to casino wagering games and in particular to a method for an optional dealer hand triggered poker bonus bet combined with a casino Blackjack card game, wherein a qualifying event in the dealer's hand triggers an optional poker bonus bet paid out according to a bonus bet payout table while playing a standard casino Blackjack card game.

### BACKGROUND OF THE INVENTION

In the past, players were given the option to place additional wagers on Blackjack games based on outcomes of their cards or a comparison of their cards and the dealer's cards. Each player won or lost their wager independently of the other players on the table and their bet was eligible to win without any predetermined conditions.

There are table games that allow the players to wager on the same event such as Craps and Baccarat but in these games, each player receives the same payout. There are wagers on Blackjack that allow the players to wager on the dealer's hand such as insurance wherein if the dealer's exposed card is an Ace, the players can make a wager that the unexposed card will be a ten-value card and each player will receive the same odds on their wager if the dealer's dealt down card is a ten-count card.

Prior art wagers that are classified as side or bonus wagers on a blackjack table require the dealer to evaluate each wager separately and each wager must be evaluated every time that the wager is made based on the rules of the game. This process will slow the pace of the game, as the dealer will need to determine the outcome of each player's wager on an individual basis.

Side wagers on Baccarat such as the Pair wager and Dragon wager have been successful and create a team environment since every player that participated in the wager will win or lose together.

None of the prior optional bonus bets are triggered by a dealer hand having a specified event, such as getting a two-card Blackjack in the dealer's two dealt cards or the dealer hand exceeding a total of 21 to trigger the optional bonus bet of a poker hand formed by designated cards against a payout table. Only one variation of blackjack in U.S. Pat. No. 6,523,831 mentions using the players two dealt cards combined with the dealer's two dealt cards to form a four-card hand bonus bet regardless of what cards are in the dealer's hand, but the prior art does not provide a player's optional bet made prior to dealing, which optional bonus bet loses unless a dealer has a specified Blackjack hand which triggers a payout to a poker hand formed by the players two dealt cards combined with other specified cards according to a bonus bet payout table, while allowing the casino Blackjack game to be played out according to standard rules.

U.S. Pat. No. 6,523,831, issued Feb. 25, 2003 to Webb; Derek J., shows card games that combine the play of Blackjack (“21”) with a 3-card Poker wager or side bet (“21+3/4”). Each player places a basic Blackjack wager and an optional side wager before the cards are dealt. Each player is then dealt a card with the dealer receiving a face-up card. Each player is dealt a second card. At this point, the outcome of each 3-card hand is determined, where a 3-card hand consists of the 2-card hand dealt to that player and the dealer's face-up card. In a 4-card version, each 4-card hand consists of the 2-card hand dealt to the player, the dealer's face-up card, and the dealer's hole card. After settling the 3-card wagers, the game of Blackjack continues in a typical fashion. After exposing the dealer's hole card, 4-card wagers are then settled. The invention advantageously retains all the features and advantages of Blackjack as well as provides the dynamics of a proposition game, without interfering with the card sequence, for enhanced player anticipation and enjoyment.

U.S. Pat. No. 6,012,719, issued Jan. 11, 2000, U.S. Pat. No. 6,371,867, issued Apr. 16, 2002, and U.S. Pat. No. 7,175,180, issued Feb. 13, 2007 to Webb; Derek J., is for card games that combine the play of Blackjack (“21”) with a 3-card Poker wager or side bet (“21+3”). Each player places a basic Blackjack wager and an optional 3-card Poker wager before the cards are dealt. Each player is then dealt a card with the dealer receiving a face-up card. Each player is dealt a second card. At this point, the outcome of each 3-card Poker hand is determined, where a player's 3-card Poker hand consists of the 2-card hand dealt to that player and the dealer's face-up card. After settling the Poker wagers, the game of Blackjack continues in a typical fashion. The invention advantageously retains all the features and advantages of Blackjack as well as provides the dynamics of 3-card Poker, without interfering with the card sequence, for enhanced player anticipation and enjoyment.

U.S. Pat. No. 7,416,187, issued Aug. 26, 2008 to Forster; Michael, provides a gaming method that comprises the following steps, which need not necessarily be performed in the exact order: providing at least two card representations to a player, each card representation comprising a symbol, the symbol having a corresponding predetermined value; providing at least two card representations to a dealer, each card representation comprising a symbol, the symbol having a corresponding predetermined value; evaluating a blackjack game outcome by comparing the values of the player and the dealer's card representations, wherein the player wins the blackjack game if the sum of the predetermined values of the player's card representations is higher than the dealer's; using two of the player's card representations for a game of poker; using two of the dealer's card representations for a game of poker; defining values for a plurality of combinations of two card representations; and evaluating a poker game outcome based on the player and the dealer's two card representations, wherein the player wins the poker game when the player possesses a two card combination that has a higher predetermined value than any of the dealer's two card combination.

U.S. Pat. No. 7,931,526, issued Apr. 26, 2011 to Ramirez; Anthony, shows a method of playing a Blackjack game provides a side-bet against a bust. Should a bust occur the bust card is combined with four subsequently dealt playing cards to define a five-card poker hand. This resulting poker hand is compared to a predetermined hierarchy of poker hands, and payouts are awarded for winning outcomes.

U.S. Pat. No. 8,020,872, issued Sep. 20, 2011 to Forster; Michael Williams, claims a gaming method that comprises the following steps, which need not necessarily be performed in the exact order: allowing a player to play a first poker game using at least two card representations; allowing the player to play a blackjack game using card representations from the first poker game; and allowing the player to play a second poker game using the card representations used in the first poker game and the blackjack game.

U.S. Pat. No. 8,382,113, issued Feb. 26, 2013 to Costa; Peter, describes a card game in which players compete against a dealer to obtain a poker hand and a blackjack hand that beats the dealer without busting by exceeding 21 points.

U.S. Pat. No. 6,773,013, issued Aug. 10, 2004 to Caldwell; Adrian, discloses a method for enhancing a conventional game of Twenty-one including the steps of providing a player an opportunity to place a Twenty-one wager to participate in the conventional game of Twenty-one; providing the player an opportunity to place a match wager that an index value of at least one of an initial two cards dealt to the player will match an index value of a face-up card dealt to a dealer; dealing the initial two cards to the player and dealing the face-up card to the dealer; verifying that the player placed the match wager and paying the player a match winning amount on the match wager if the index value of at least one of the initial two cards dealt to the player matches the index value of the face-up card; and continuing with play of the conventional game of Twenty-one. The method can include the further steps of: providing the player an opportunity to place a poker wager that a two-card poker hand value of the initial two cards dealt to the player will equal one of a plurality of paying two-card poker hand values; and verifying that the player placed the poker wager and paying the player a poker winning amount if the two-card poker hand value of the initial two cards dealt to the player equals one of the plurality of paying two-card poker hand values.

U.S. Pat. No. 6,536,767, issued Mar. 25, 2003 to Keller; David, indicates a variation of Blackjack (Blackjack Royal) in which a player may make a side bet on a dealer's face up card having a point value of ten and a plurality of side bets relating to a player's first two dealt cards.

U.S. Pat. No. 6,158,741, issued Dec. 12, 2000 to Koelling; David C, puts forth a method of playing blackjack with a side wager that includes a side wager which is typically set at $1 per hand per player. Where the dealer shows a card having a value of ten, and the player shows two cards having a cumulative value of twenty, the player is a winner. Where either of these two conditions are not met, the player loses the side wager. Where the dealer has a ten-value up card and the player has two cards totaling twenty including aces and nines, the player wins a first amount. Where the player's cards are both of the same suit, the player wins a second, typically larger, amount. Where the player's cards are of the same rank, e.g. both Kings, the player wins a third amount. Where the player's cards are both the same rank and the same suit, the player wins a fourth amount. Where the player's cards are both the same suit and the same rank, and also the same suit and rank as the dealer's face up card, the player wins a significantly larger fifth amount. Where both of the player's cards and both of the dealer's cards are the same, e.g. all Queens of diamonds, then the player wins the jackpot. Because the game is played with multiple decks of cards, such an occurrence is possible. The game is adapted to both casino table, computer and video gaming device play.

U.S. Pat. No. 7,562,877, issued Jul. 21, 2009 to Hess, legal representative, et al., concerns a method of playing a blackjack game permits a player to place two wagers, obtaining two blackjack hands, and a bonus wager to participate in a side bet. A dealer deals two up cards for each of the two wagers, and the side bet is resolved by evaluating the 4 up-cards in accordance with a predetermined hierarch of winning poker results. An alternative manner of play includes the dealer's up-card with the 4 up-cards of the player, with resolution obtained utilizing winning 5-card poker results.

U.S. Pat. No. 7,222,855, issued May 29, 2007 to Sorge; Nicholas, illustrates a method for playing a modified blackjack game—called Poker blackjack game—between a dealer and at least one player. Each player places a first wager, the outcome of which is determined by conventional rules of blackjack play. Players may optionally place an additional wager or side bet corresponding to a five-card poker hand made up of two cards dealt to the player and three community cards. A predetermined multiple of an amount of the additional wager is paid out or collected based on the rank of the poker hand. Players may also place additional wagers corresponding to a predicted color of their initial two card hand.

U.S. Pat. No. 7,066,465, issued Jun. 27, 2006 to Daines; Shirley discloses a side bet for blackjack style card game which may be implemented in any blackjack-style card game method provides an opportunity to win a bet based on combinations of three cards which may be the player's first two cards and the dealer's first card. The player may win the side bet with certain combinations of cards having different winning payouts.

U.S. Patent Application #20040239033, published Dec. 2, 2004 by Zahedi, Fardin Maxmillian, claims a method of playing a card game based on the conventional game of Twenty-One and the conventional game of Poker. A player playing the game has the option of playing both poker and Twenty-One simultaneously and also has the option of participating in a bonus game for larger payouts. In the game, the face cards are revalued and the total value of the Poker hand may not exceed 21.

U.S. Patent Application #20080113703, published May 15, 2008 by Kekempanos, Ermirjona Hasanaj et al., describes a method for playing blackjack with a two-card poker wager (21+2). The card games combine the play of Blackjack (“21”) with a 2-card Poker wager or side bet (“21+2”). Each player places a basic Blackjack wager and an optional 2-card Poker wager/side wager before the cards are dealt. Each player is then dealt a card with the dealer receiving a face-up card. Each player is dealt a second card. At this point, the outcome of each 2-card Poker hand is determined, where a player's 2-card Poker hand consists of the 2-card hand dealt to that player and/or using the dealer's face-up card. After settling the Poker wagers, the game of Blackjack continues in a typical fashion. The invention advantageously retains all the features and advantages of Blackjack as well as provides the dynamics of 2-card Poker, without interfering with the card sequence, for enhanced player anticipation and enjoyment. The game can be played with Baccarat wherein each player places a basic player or banker or tie wager and an optional 2-card Poker wager/side wager before the cards are dealt.

Two prior art Blackjack casino card games also include a progressive payout with standard Blackjack play. Neither patent involves a progressive payout of an optional poker hand bonus bet triggered by a specific dealer hand event. The prior art progressive payouts are made only based on player hands, not involving the dealer hand, and the prior art payouts require that the Blackjack game is being played with multiple card decks, wherein the player hands would not be possible using only one deck of cards in the Blackjack game.

U.S. Pat. No. 6,336,857, issued Jan. 8, 2002 to McBride; Scott, is for an electronic side bet progressive jackpot gaming table apparatus including a color-coded player's banking center which includes a coin slot an electronic button means, a digital display means. The apparatus also includes a dealer key pad having a plurality of electronic button means for the dealer to suitably conduct a side bet progressive jackpot game. The invention furthermore relates to a method of operating the electronic side bet progressive jackpot gaming table apparatus. In addition, methods of playing casino Blackjack games employing an inventive deck of same color-coded playing cards are disclosed.

U.S. Pat. No. 5,577,731, issued Nov. 26, 1996 to Jones; Daniel A., provides a method of progressive jackpot twenty-one wherein the predetermined winning arrangement of cards include two aces, three aces and four aces. The method of the present invention involves a conventional live casino or video machine type Twenty-One game (also known as Blackjack), in which, in addition to his normal wager, a player has the option of making an additional wager that becomes part of, and makes the player eligible to win, a jackpot, and most preferably, a progressive jackpot. If the player's Twenty-One hand comprises a particular, predetermined arrangement of cards, the player will win all, or part of, the amount of the progressive jackpot. In a Twenty-One game using any number of decks of cards, the predetermined winning arrangements of cards preferred in the present invention are four black or red Aces; three suited Aces; three unsuited Aces; two suited Aces; and two unsuited Aces, which preferably win, respectively, highest, second highest, third highest, fourth highest, and fifth highest amounts of the jackpot.

What is needed is a method of playing a combined Blackjack and optional Poker bonus bet casino card game based on a dealer hand qualifying event, a dealer trigger hand, for activating the optional bonus bet for bonus betting players to win according to a bonus poker bet payout table or for the players to lose the optional bonus bet if the dealer does not get a dealer trigger hand, wherein the dealer trigger hand may comprise a two-card Blackjack in the dealer's two dealt cards or the dealer's hand exceeding a total of 21 points during the course of play, either one or the other of which trigger a poker hand formed by the two dealt player cards combined with a designated number of other cards forming a poker hand paid out according to bonus poker payout table, wherein an additional progressive bonus payout may be made according for a top poker hand according to the payout table, and wherein the Blackjack game is played out according to standard casino Blackjack rules of play.

### SUMMARY OF THE INVENTION

A primary object of the present invention is to provide a method of playing a combined Blackjack and optional Poker bonus bet casino card game based on a dealer hand qualifying event, a dealer trigger hand, for activating the optional bonus bet for bonus betting players to win according to a bonus poker bet payout table or for the players to lose the optional bonus bet if the dealer does not get a dealer trigger hand, wherein the dealer trigger hand may comprise a two-card Blackjack in the dealer's two dealt cards or the dealer's hand exceeding a total of 21 points during the course of play, either one or the other of which trigger a poker hand formed by the two dealt player cards combined with a designated number of other cards forming a poker hand paid out according to bonus poker payout table, wherein an additional progressive bonus payout may be made according for a top poker hand according to the payout table, and wherein in every hand the Blackjack game is played out according to standard casino Blackjack rules of play.

One embodiment of the invention is a method of playing a wager on a Blackjack game where the wager will win based on a payout table if the dealer's dealt hand is a Blackjack; a two-card combination consisting of an Ace and a ten-value card. The payout table will be based on a four-card poker hand formed by the combination of the dealer's dealt two-card hand that formed a two-card Blackjack and the player's dealt two-card hand. If the dealer's dealt hand is any other hand besides a two-card Blackjack, the wager will lose. The Blackjack game is played out according to standard casino Blackjack rules of play.

Players that choose to make this additional bonus wager on a Blackjack game will place their wager in the identified bonus bet location. If the dealer's hand achieves the triggering combination of a Blackjack, the player's two dealt cards combined with the dealer's Ace and ten-count card form a four-card poker hand. Each wager will win based on the ranking of the poker hand compared with the payout table. One payout table will rank the hands in the following order; royal straight flush, three of a kind, straight, flush, two pairs, pair, and high card.

In one version of this embodiment, a progressive meter is installed that will be won when a player initiates a wager and the dealer's dealt hand is a two-card Blackjack and the player's two cards combined with the dealer's two cards form a royal straight flush of a predetermined suit; an example would be a royal straight flush in spades. In another version of this embodiment, the top prize for a royal straight flush equals or exceeds 5,000 to 1 and is considered a jackpot type payout.

Other embodiments of this invention allow for different predetermined qualifying events or triggers of the dealer's hand to initiate the bonus poker payout table for the wager. In every embodiment, if the dealer's hand fails to reach a qualifying event, the wager will lose. Additionally, in every embodiment, if the dealer's hand does meet the qualifying event, an additional consideration will be the determining factor to value the outcome. The additional consideration may or may not incorporate the dealer's hand that qualifies the wager to win.

By incorporating a qualifying event for the dealer's hand that initiates the pay table for a wager such as a dealer's two-card dealt blackjack triggering the combination of the player's two cards and the dealer's two cards that formed the blackjack to make a four card poker hand, the team atmosphere exists but each player is rewarded at different amounts based on their combined hand. Additionally, by using a qualifying event based on the dealer's hand to initiate a pay table, all of the wagers lose if the qualifying event is not met which will not have as much of an effect on game pace and is easier for the dealer to facilitate the overall game. The Blackjack game is played out according to standard casino Blackjack rules of play.

### DESCRIPTION OF THE DRAWINGS

These and other details of the present invention will be described in connection with the accompanying drawings, which are furnished only by way of illustration and not in limitation of the invention, and in which drawings:

FIG. 1 is a plan view of a casino card game playing table layout for a standard casino blackjack card game played in combination with an optional four-card poker hand bonus side bet showing the player layouts, standard Blackjack payouts, and four-card poker hand bonus side bet payout tables facing the players and the dealer layout and payout table facing the dealer on the other side of the playing table from the players;

FIG. 2 is an exploded plan view showing the Blackjack payout, dealer play limits, insurance bet with odds, and indication of the four-card poker hand cards shown in empty elongated curved boxes facing the players on the layout of FIG. 1 for the standard casino blackjack card game played in combination with an optional four-card poker hand bonus bet of the present invention;

FIG. 3 is an exploded plan view showing a player layout with demarked player betting locations for the Blackjack bets and the optional four-card poker hand bonus bets and the four-card poker bonus bet payout table on the casino card table of FIG. 1 for the standard casino blackjack card game played in combination with an optional four-card poker hand bonus bet of the present invention;

FIG. 4 is an elevational view of a simulation of the playing table layout of the standard casino Blackjack card game played in combination an optional four-card poker hand bonus side bet of the present invention shown on a screen of an electronic simulation device showing a simulation of the player layouts and payout tables and the dealer layout and pay table, a dealer card layout and a player card layout showing the Blackjack cards used for the Blackjack game and demarking which of the four Blackjack cards are used for the optional four-card poker hand bonus side bet, and the control areas for the player to activate in making choices during the play of the Blackjack game;

FIG. 5 is an elevational view of a simulation of the playing table layout of the standard casino Blackjack card game played in combination with an optional four-card poker hand bonus side bet of the present invention shown on a screen of a computer device showing a simulation of the player layouts and the optional four-card poker hand bonus side bet payout table, and the dealer layout and pay table, a dealer card layout and a player card layout showing the Blackjack cards used for the Blackjack game and demarking which of the four Blackjack cards are used for the optional four-card poker hand bonus side bet, and the control areas for the player to activate in making choices during the play of the Blackjack game;

FIG. 6 is an elevational view of a simulation of a player layout for the playing table layout of the standard casino Blackjack card game played in combination with an optional four-card poker hand bonus side bet of the present invention, shown on a touch screen of a wireless device showing a simulation of a player casino table layout and pay table and showing a dealer card layout and a player card layout showing the Blackjack cards used for the Blackjack game and demarking which of the four Blackjack cards are used for the optional four-card poker hand bonus side bet, and the control areas for the player to activate in making choices during the play of the Blackjack game.

### DETAILED DESCRIPTION OF THE INVENTION

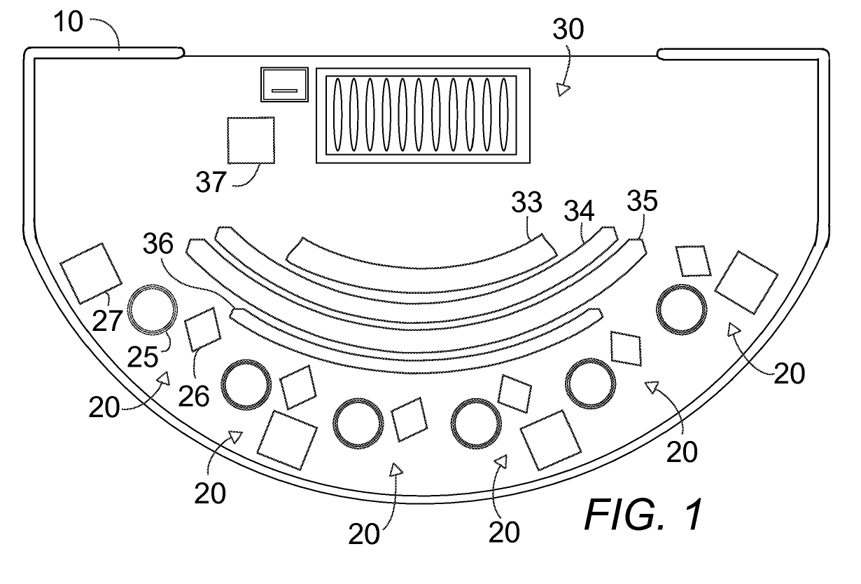

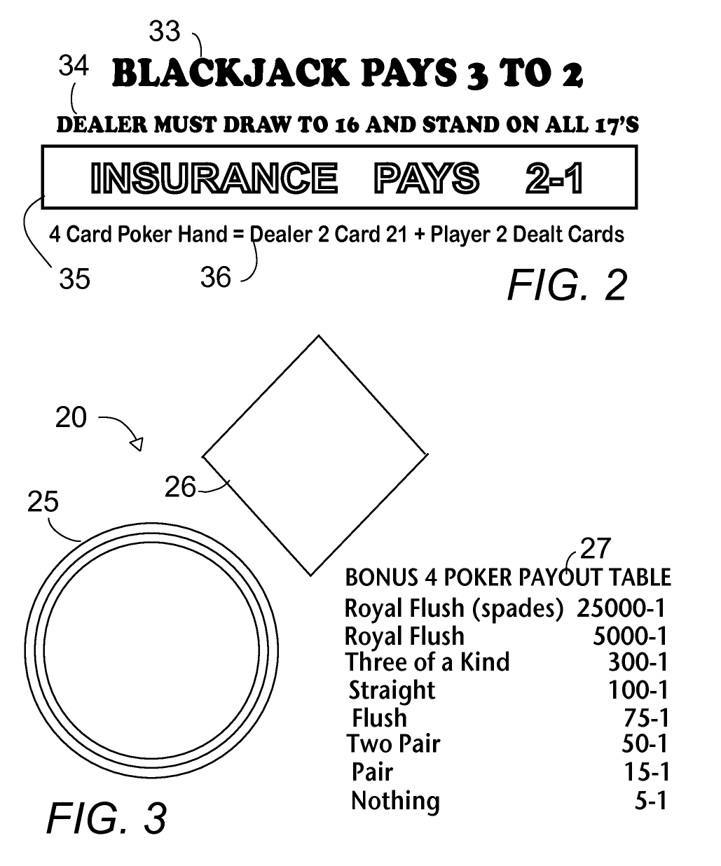

In FIGS. 1-6, the present invention comprises a method of playing a standard casino Blackjack game in combination with an optional bonus side bet for a poker hand comprising at least the two player dealt cards without affecting the play of the standard casino Blackjack game provides a payout of the optional bonus side bet triggered by a dealer's hand comprising a predetermined qualifying event for triggering the optional bonus poker hand bet. The player optional bonus bet poker hand paid out according to a bonus poker bet payout table for a poker hand comprising one of a number of payout table options only if the dealer's hand has a predetermined qualifying event and the bonus poker bet will lose if the dealer's hand does not have the predetermined qualifying event. The Blackjack game is played out according to standard casino Blackjack rules of play.

The method of the present invention may further comprise a step of paying out at least one of the payout table options based on a result that meets the criteria to win the funds accrued in a progressive meter based on accumulation of an amount taking a predetermined rate of increment of each wager.

In the preferred method of the present invention, the dealer's hand predetermined qualifying event comprises a dealer's two dealt cards forming a two-card Blackjack comprising an Ace and any 10 value card to trigger a payout of the optional bonus poker hand side bet, the optional bonus side bet comprising a bet on a four-card poker hand formed by a combination of a player's two dealt cards with the dealer's dealt two-card Blackjack hand, having an Ace and any one of a Ten, a Jack, a Queen, or a King, to form a four-card poker hand paid out against a bonus bet four-card poker payout table; the optional bonus poker hand side bet being automatically lost if a dealer's two dealt cards do not form a two-card Blackjack.

In FIGS. 1-6, a method of playing a standard casino Blackjack card game in combination with an optional bonus side bet for a four-card poker hand formed using the same cards used in the Blackjack game without affecting the play of the standard casino Blackjack game. A payout of the optional bonus side bet is triggered by a dealer's dealt hand comprising a two-card Blackjack hand comprising an Ace and any 10 point value card. The optional bonus side bet comprises a bet on a four-card poker hand formed by a combination of a player's two dealt cards with the dealer's dealt two-card Blackjack hand, formed by an Ace and any one of a Ten, Jack, Queen, or King, to form a four-card poker hand paid out against a bonus bet four-card poker payout table; the optional bonus side bet being automatically lost if a dealer's two dealt cards do not form a two-card Blackjack hand.

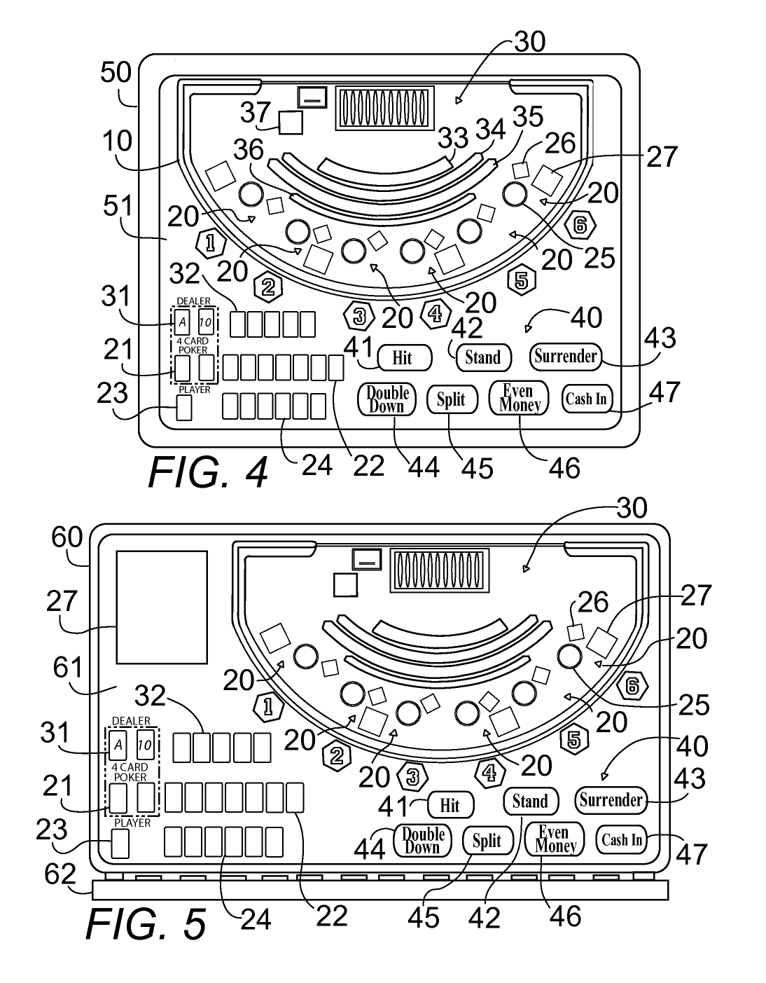

The method comprises the following steps:
a) a first step of providing at least one standard deck of playing cards used for playing a standard casino Blackjack card game;
b) a second step of providing a casino Blackjack card game playing layout 10 comprising: a dealer location 30 showing a Blackjack payout 33, dealer play limits 34, insurance bet with odds 35, and a card indication 36 of the four-card poker hand cards; at least one player position 20 comprising a first betting location 25 for standard Blackjack bets for a player; at least one second betting location 26 for four-card poker optional bonus side bets for the player; and at least one four-card poker optional bonus side bet payout table 27, as shown in FIGS. 1 and 3;
c) a third step of placing at least one standard bet on the casino Blackjack card game layout in the at least one first betting location 25;
d) a fourth step of placing an optional four-card poker bonus side bet on the casino Blackjack card game layout in the at least one second betting location 26;
e) a fifth step of dealing two cards to each player and two cards to the dealer for playing the standard casino Blackjack card game;
f) if the dealer's two card dealt hand comprises a two-card Blackjack hand 31, as shown in FIGS. 4, 5, and 6, having an Ace and one ten count card, a sixth step of turning all cards face up and paying out to each player making the optional bonus four-card poker side bet, a payout on a four-card poker hand formed by a combination of a player's two dealt cards 31 with the dealer's dealt two-card Blackjack hand 31 having an Ace and a ten count card to form a four-card poker hand paid out against an optional bonus side bet four-card poker payout table 27; if the dealer's hand does not comprise a two-card Blackjack hand, an alternate sixth step of collecting the optional bonus four-card poker side bet from each player making the optional bonus side bet;
g) a seventh step of proceeding with the play of the standard casino Blackjack card game, including paying out or collecting player Blackjack bets according to standard casino Blackjack rules.

The sixth step of paying out the optional four card poker side bet according to the four card poker payout table comprises using the following set of odds for payout of the optional four card poker side bet:

| | |
|---|---|
| Royal Straight Flush (Spades) | 25000 to 1 |
| Royal Straight Flush | 5000 to 1 |
| Three of a Kind | 200 to 1 |
| Straight | 100 to 1 |
| Flush | 75 to 1 |
| Two Pair | 50 to 1 |
| Pair | 15 to 1 |
| Nothing | 5 to 1 |

The method may further comprise a step of providing a progressive bet meter funded by a predetermined rate of increment of each wager, wherein the sixth step comprises paying out a progressive jackpot if the four-card poker hand formed by the player's two dealt cards and the dealer's two card Blackjack dealt cards result in a royal straight flush in a predetermined suit, and wherein the sixth step of paying out the optional bonus four-card poker side bet according to the four card poker payout table including a progressive bet further comprises using the following set of odds for payout of the optional bonus four-card poker side bet:

| | |
|---|---|
| Royal Straight Flush (Spades) | 10000+ to 1 (Progressive Jackpot) |
| Royal Straight Flush | 10000 to 1 |
| Three of a Kind | 100 to 1 |
| Straight | 75 to 1 |
| Flush | 50 to 1 |
| Two Pair | 40 to 1 |
| Pair | 10 to 1 |
| Nothing | 5 to 1 |

In FIGS. 1-3, the second step of the casino Blackjack card game in combination with an optional bonus four-card poker side bet comprises providing the playing layout 10 on a casino Blackjack gaming table having at least one player layout 20 for at least one player sitting at the casino Blackjack gaming table and having a dealer layout 30 for a dealer at the casino Blackjack gaming table to play the casino Blackjack card game in combination with an optional bonus four-card poker side bet according to the method of the present invention.

The second step of the casino Blackjack card game in combination with an optional bonus four-card poker side bet may comprise providing the casino Blackjack playing layout on a simulation device, resembling the casino table layout 10 of FIG. 1, for at least one player to play the casino Blackjack card game in combination with an optional bonus four-card poker side bet according to the method of the present invention.

The second step of the casino Blackjack card game in combination with an optional bonus four-card poker side bet may comprise providing the playing layout on a mechanical simulation device, resembling the casino table layout 10 of FIG. 1, for at least one player to play the casino Blackjack card game in combination with an optional bonus four-card poker side bet according to the method of the present invention.

In FIGS. 3-6, the second step of the casino Blackjack card game in combination with an optional bonus four-card poker side bet comprises providing the playing layout on an electronic simulation device 50, 60, or 70 having an electronic viewing screen 51, 61, or 71 of the playing layout for at least one player and further comprises providing a plurality of control areas 40 on the electronic viewing screen for the player to activate in making choices during the play of the Blackjack game, including Hit 41, Stand 42, Surrender 43, Double Down 44, Split 45, Even Money 46, and Cash In 47 to be selected electronically by the player for communication with the electronic device about the player choices during the play of the casino Blackjack card game in combination with an optional bonus four-card poker side bet according to the method of the present invention.

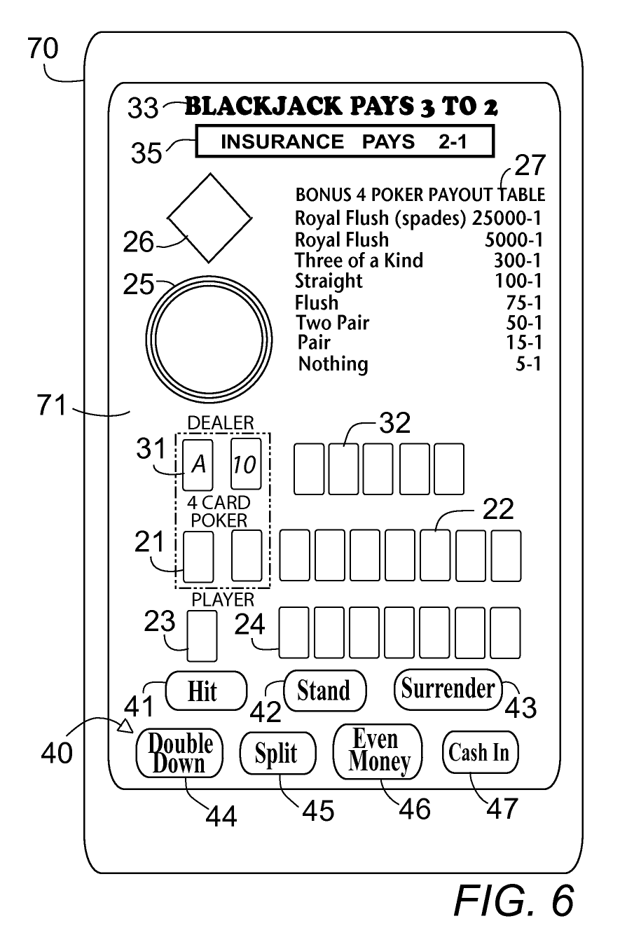

In FIG. 6, the second step of the casino Blackjack card game in combination with an optional bonus four-card poker side bet comprises providing the playing layout on a handheld electronic simulation device 70, the handheld electronic simulation device comprising a touch screen 71 means for interacting with the handheld electronic simulation device, the at least one player touching the screen 71 to control the electronic simulation device in making player choices during the play of the casino Blackjack card game in combination with an optional bonus four-card poker side bet according to the method of the present invention.

In FIGS. 4, 5, and 6, the second step of the casino Blackjack card game in combination with an optional bonus four card poker side bet comprises providing the playing layout on an electronic device 50, 60, and 70 having a connection to a remote network to play the casino Blackjack card game in combination with an optional bonus four-card poker side bet according to the method of the present invention.

The second step of the casino Blackjack card game in combination with an optional bonus four card poker side bet may comprise providing the playing layout on an electronic device having a connection to a remote network to play the casino Blackjack card game in combination with an optional bonus four-card poker side bet according to the method of the present invention on an electronic device taken from the list of electronic devices including a computer, a handheld device, a telephonic device, an entertainment device, a gaming device, and a television device.

The first step of providing at least one standard deck of playing cards comprises providing any of the numbers of standard decks of playing cards taken from the list of decks including one deck, two decks, four decks, six decks, and eight decks.

An alternate method of a casino Blackjack game combined with an optional poker hand bonus side bet comprises a dealer's hand predetermined qualifying event comprising a dealer's Blackjack hand exceeding a total of 21 points to trigger a payout of the optional poker hand bonus side bet, the optional poker hand bonus side bet comprising a bet on a poker hand paid out against an optional bonus bet poker payout table; the optional bonus side bet being automatically lost if a dealer's Blackjack hand does not exceed a total of 21.

The alternate method may comprise a step that when the optional bet placing player hands that still have cards that meet the standards to be involved in the Blackjack game at the time the dealer's hand reached the predetermined total greater than 21, the step comprises combining the player cards and the dealer cards to form a five-card poker hand that will be compared with an optional bonus five-card poker side bet payout table.

A second alternate method may comprise a step that when the dealer's dealt hand is a two-card Blackjack having a total of 21, the step comprises combining an optional betting player's two dealt cards with a predetermined number of cards that are introduced to the game from a subset of previously unexposed cards to form a poker hand to be compared with an optional bonus side bet payout table; if the dealer's hand is not a Blackjack, the wager will lose.

The second alternate method comprises the step of the dealer issuing each player that initiated the optional bonus side bet one additional card combining with the players two dealt cards forming a three-card poker hand paid against a predetermined optional bonus side bet three-card poker payout table.

The second alternate method may alternately comprise a step of the dealer issuing each player that initiated the optional bonus side bet two additional cards combining with the players two dealt cards forming a four-card poker hand paid against a predetermined optional bonus four-card poker side bet payout table.

In use, according to the present method of playing a standard casino Blackjack card game combined with an optional poker hand bonus side bet, the standard casino Blackjack card game is played out until a dealer hand trigger event occurs and the optional poker hand bonus side bet is paid out against a designated poker hand and the Blackjack card game played to completion according to standard casino Blackjack regulations. If a dealer hand trigger event does not occur any optional poker hand bonus side bets are lost.

The progressive jackpot may be accrued from portions of wagers at all Blackjack tables in a casino accumulated together.

It is understood that the preceding description is given merely by way of illustration and not in limitation of the invention and that various modifications may be made thereto without departing from the spirit of the invention as claimed.

What is claimed is:

1. A method of administering a Bonus Poker Bet Blackjack casino card game at a gaming table the method comprising:
providing a Bonus Poker Bet Blackjack casino card playing table comprising a playing surface defining a dealer layout area and a plurality of player layout areas, each player layout area of the plurality of player layout areas defining a Blackjack ante betting location, a four-card poker bonus betting location, and a four-card poker bonus bet payout table showing payout odds for paying out a four-card poker hand comprising a royal straight flush having Ace, King, Queen, Jack all of a same specified suit; a three of a kind; a straight; a flush; two pair; a pair; or any other wagered four-card poker hand not meeting any of the previous qualifications;
providing at least one standard 52-card deck of physical playing cards where the physical playing cards are randomized;
receiving a Blackjack ante bet in the form of at least one physical monetary token placed in the Blackjack ante betting location of one player layout area of the plurality of player layout areas;
receiving an optional four-card poker bonus bet in the form of at least one physical monetary token placed in the four-card poker bonus betting location of the one player layout area;
distributing onto the surface of the playing table from the at least one randomized 52-card deck of physical playing cards an initial two-card dealer hand comprising one physical face-down card and one physical face-up card on the dealer layout area and a player hand comprising two physical face-up cards on the one player layout area;
analyzing the initial dealt two-card dealer hand to determine whether the initial two-card dealer hand comprises a two-card blackjack, wherein:
when the initial two-card dealer hand comprises the two-card blackjack, forming the four-card poker hand using the cards of the initial dealt two-card dealer hand and the cards of the player hand associated with the one player layout area on which the optional four-card poker bonus bet was received; and resolving the four-card poker bonus bet by paying out each four-card poker bonus bet according to the four-card poker bonus bet payout table; and
when the initial two-card dealer hand does not comprise the two-card blackjack, collecting all the four-card poker bonus bets; and
resuming play of the Blackjack casino card game and resolving the Blackjack ante bets of the Blackjack casino card game.

2. The method of claim 1 wherein paying out each four-card poker bonus bet according to the four-card poker bonus bet payout table comprises paying out indicated table odds for the combination of the player hand and the initial dealt two-card dealer hand with the two-card Blackjack cards forming the four-card poker hand.

3. The method of claim 3 wherein providing a Bonus Poker Bet Blackjack casino card playing table comprises providing a plurality of Bonus Poker Bet Blackjack casino card playing tables, and wherein the method further comprises taking a predetermined portion of each received bet from each of the plurality of playing tables to provide progressive jackpot payout funds reported in a progressive meter, and paying out at least a portion of the progressive jackpot funds shown in the progressive meter for at least one of the four-card poker hands.

4. The method of claim 3 wherein paying out the optional bonus four-card poker hand bet according to the optional bonus bet four-card poker hand payout table comprises paying out according to the following set of odds:

| | |
|---|---|
| Royal Straight Flush (Spades) | 25000 to 1 |
| Royal Straight Flush | 5000 to 1 |
| Three of a Kind | 200 to 1 |
| Straight | 100 to 1 |
| Flush | 75 to 1 |
| Two Pair | 50 to 1 |
| Pair | 15 to 1 |

5. The method of claim 2 wherein paying out the optional bonus four-card poker hand bet and the paying out of the at least a portion of the progressive jackpot funds shown in the progressive meter according to the optional bonus bet four-card poker hand payout table comprises paying out according to the following set of odds:

| | |
|---|---|
| Royal Straight Flush (Spades) | 10000+ to 1 (Progressive Jackpot) |
| Royal Straight Flush | 10000 to 1 |
| Three of a Kind | 100 to 1 |
| Straight | 75 to 1 |
| Flush | 50 to 1 |
| Two Pair | 40 to 1 |
| Pair | 10 to 1 |
| Nothing | 5 to 1 |

6. The method of claim 1 wherein the optional four-card poker bonus bet is an amount equal to the ante bet.

7. The method of claim 1 wherein providing at least one standard deck of playing cards comprises providing any of the numbers of standard decks of playing cards taken from the list of decks including one deck, two decks. four decks, six decks, and eight decks.

8. A method of administering a Bonus Poker Bet Blackjack casino card game on an electronic gaming machine, the method comprising:
providing an electronic simulation device programmed for administering a Bonus Poker Bet Blackjack casino card game, the device comprising a screen configured to display a virtual representation of a Bonus Poker Bet Blackjack casino card game playing surface illustrated to define a dealer layout area and a player layout area, and a four-card poker bonus bet payout table location showing payout odds for paying out a four-card poker hand comprising a royal straight flush, three of a kind, a straight, a flush. two pair, a pair, or any other wagered four-card poker hand not meeting any of the previous qualifications, the electronic simulation device configured with at least one input device to receive commands inputted by a player to place a bet, hit, stand, surrender, double down, split, even money, and cash in at the electronic simulation device;
providing at least one standard 52-card deck of virtual playing cards where the virtual playing cards are randomized;
receiving a Blackjack ante bet via the at least one input device in the form of at least one virtual monetary token;
receiving an optional four-card poker bonus bet via the at least one input device in the form of at least one virtual monetary token;
dealing from the at least one randomized 52-card deck of virtual playing cards, an initial two-card dealer hand displaying one virtual card face-down and one virtual card face-up on the dealer layout area and a player hand displaying two virtual cards face-up on the player layout area;
analyzing the initial dealt two-card dealer band to determine whether the initial two-card dealer hand comprises a two-card blackjack, wherein:
when the initial two-card dealer hand comprises the two-card blackjack, forming a four-card poker hand using the initial two-card dealer hand comprising the two-card blackjack and the player hand, and resolving the four-card poker bonus bet by paying out the four-card poker bonus bet according to the four-card poker bonus bet payout table; and
when the initial two-card dealer hand does not comprise the two-card blackjack, collecting the four-card poker bonus bet; and
resuming play of the Blackjack casino card game and resolving the Blackjack ante bets of the Blackjack casino card game.

9. The method of claim 8 wherein providing an electronic simulation device comprises providing an electronic simulation device having a connection to a remote network.

10. The method of claim 9 wherein providing an electronic simulation device comprises providing at least one of a computer, a handheld device, a telephonic device, an entertainment device, a gaming device, and a television device.

11. The method of claim 9 wherein providing the electronic simulation device having a connection to a remote network comprises providing an electronic simulation device having a wired connection to the remote network.

12. The method of claim 9 wherein providing the electronic simulation device having a connection to a remote network comprises providing an electronic simulation device having a wireless connection to the remote network.

13. The method of claim 9 wherein providing the electronic simulation device having a connection to a remote network comprises providing a communication electronic simulation device having the connection to the remote network.

14. The method of claim 9 wherein providing an electronic simulation device comprises providing a handheld electronic simulation device, the screen of the electronic simulation device configured as a touch screen of the handheld electronic simulation device.

15. The method of claim 9 wherein providing an electronic simulation device comprises providing a plurality of electronic simulation devices, wherein the method further comprises taking a predetermined portion of each received bet from each of the plurality of electronic simulation devices to provide progressive jackpot payout funds reported in a progressive meter, and paying out at least a portion of the progressive jackpot funds accrued shown in the progressive meter for at least one of the four-card poker hands
